(19) United States
(12) Patent Application Publication
(10) Pub. No.: US 2014/0226649 A1
(43) Pub. Date: Aug. 14, 2014

(54) SYNCHRONIZATION SIGNALS IN A WIRELESS COMMUNICATION SYSTEM

(71) Applicant: FUJITSU LIMITED, Kawasaki-shi (JP)

(72) Inventors: Matthew WEBB, London (GB); Timothy MOULSLEY, Caterham Surrey (GB); Yiwei FANG, High Wycombe (GB)

(73) Assignee: FUJITSU LIMITED, Kawasaki-shi (JP)

(21) Appl. No.: 14/252,212

(22) Filed: Apr. 14, 2014

Related U.S. Application Data
(63) Continuation of application No. PCT/EP2012/051452, filed on Jan. 30, 2012.

(51) Int. Cl. H04W 56/00; H04L 5/00

(52) U.S. Cl. CPC H04W 56/00; H04L 5/0053
USPC 370/350

(57) ABSTRACT

Cell-specific or transmission point (TP)-specific information is indicated to a UE based on the subframe in which a cell/TP transmits its primary and secondary synchronization sequences (PSS and SSS). The principal scenario of interest is a dense deployment of picocells/TPs which are under the control of an overlaid macrocell's eNodeB. Since the antenna port from which PSS/SSS are transmitted can change between subframes, the invention associates some information (such as zero power CSI-RS) related to the picocell/TP transmitting the PSS/SSS with a particular PSS/SSS and subframe combination. The table of associations can be provided by signalling from the macrocell eNodeB, and the information being associated can then be obtained by the UE from any picocell/TP it is in range of without additional signalling being necessary.

### CROSS-REFERENCE TO RELATED APPLICATIONS

This is a continuation of International Application No. PCT/EP2012/051452, filed on Jan. 30, 2012, now pending, the contents of which are herein wholly incorporated by reference.

### FIELD OF THE INVENTION

The present invention relates to wireless communication systems, for example systems compliant with the 3GPP Long Term Evolution (LTE) and 3GPP LTE-A (LTE-Advanced) groups of standards, and more particularly to synchronization signals employed in such systems.

### BACKGROUND OF THE INVENTION

Wireless communication systems are widely known in which base stations (BSs) communicate with user equipments (UEs) (also called subscriber or mobile stations) within range of the BSs.

The geographical area covered by one or more base stations is generally referred to as a cell, and typically many BSs are provided in appropriate locations so as to form a network covering a wide geographical area more or less seamlessly with adjacent and/or overlapping cells. (In this specification, the terms “system” and “network” are used synonymously). Each BS divides its available bandwidth into individual resource allocations for the user equipments which it serves. The user equipments are generally mobile and therefore may move among the cells, prompting a need for handovers between the base stations of adjacent cells. A user equipment may be in range of (i.e. able to detect signals from) several cells at the same time, but in the simplest case it communicates with one “serving” cell.

The direction of communication from the base station to the UE is referred to as the downlink (DL), and that from the UE to the base station as the uplink (UL). Two well-known transmission modes for a wireless communication system are TDD (Time Division Duplexing), in which downlink and uplink transmissions occur on the same carrier frequency and are separated in time, and FDD (Frequency Division Duplexing) in which transmission occurs simultaneously on DL and UL using different carrier frequencies.

Resources in such a system have both a time dimension and a frequency dimension. In LTE, the time dimension has units of a symbol time or “slot” (where a “slot” has typically a duration of seven symbol times), as indicated in FIG. 1. The resources in the time domain are further organised in units of frames, each having a plurality of “subframes”. Frames follow successively one immediately after the other, and each is given a system frame number (SFN).

In one frame structure for LTE, the 10 ms frame is divided into 20 equally sized slots of 0.5 ms as illustrated in FIG. 1. A sub-frame consists of two consecutive slots, so one radio frame contains 10 sub-frames. An FDD frame consists of 10 uplink subframes and 10 downlink subframes occurring simultaneously. In TDD, the 10 subframes are shared between UL and DL and various allocations of subframes to downlink and uplink are possible, depending on the load conditions. Subframes may consequently be referred to as uplink subframes or downlink subframes.

Meanwhile the frequency dimension is divided in units of subcarriers. The UEs are allocated, by a scheduling function at the eNodeB, a specific number of subcarriers for a predetermined amount of time. Such allocations typically apply to each subframe. Resources are allocated to UEs both for downlink and uplink transmission (i.e. for both downlink subframes and uplink subframes).

The transmitted signal in each slot is described by a resource grid of sub-carriers and available OFDM (Orthogonal Frequency-Division Multiplexing) symbols, as shown in FIG. 2. Each element in the resource grid is called a resource element, and each resource element corresponds to one symbol. Each downlink slot has a duration Tₛₗₒₜ with either 7 or 6 symbols per slot, depending on whether a short or long cyclic prefix (CP) is used. There are a total of NBW subcarriers in the frequency domain, the value of this number depending on the system bandwidth. A block of 12 subcarriers×7 or 6 symbols is called a Resource Block. The Resource Block is the basic unit of scheduling for allocation of resources in the UEs.

A base station typically has multiple antennas and consequently can transmit (or receive) multiple streams of data simultaneously. Physical antennas controlled by the same base station may be widely geographically separated, but need not be so. A group of physical antennas which provides a logically distinct communication path to a UE is termed an antenna port (and may also be considered to be a virtual antenna). Antenna ports may comprise any number of physical antennas. Various transmission modes are possible via the antenna ports, including (in LTE-A) a “transmission mode 9” for closed-loop multiple-input, multiple-output (MIMO). A subset of the physical antennas, which are all in the same geographical location, may be regarded as a distinct transmission point under control of the same base station.

Several “channels” for data and signalling are defined at various levels of abstraction within the network. FIG. 3 shows some of the channels defined in LTE at each of a logical level, transport layer level and physical layer level, and the mappings between them.

At the physical layer level, on the downlink, user data is carried on the Physical Downlink Shared Channel (PDSCH). There are various control channels on the downlink, which carry signalling for various purposes; in particular the Physical Downlink Control Channel, PDCCH, is used to carry, for example, scheduling information from a base station (called eNodeB in LTE) to individual UEs being served by that base station. The PDCCH is located in the first OFDM symbols of a slot.

Each base station broadcasts a number of channels and signals to all UEs within range, whether or not the UE is currently being served by that cell. Of particular interest for present purposes, these include a Physical Broadcast Channel PBCH as shown in FIG. 3, as well as (not shown) a Primary Synchronization Signal PSS and Secondary Synchronization Signal SSS, described in more detail below. PBCH carries a so-called Master Information Block (MIB), which gives the UE basic information including system bandwidth, number of transmit antenna ports, and system frame number.

Meanwhile, on the uplink, user data and also some signalling data is carried on the Physical Uplink Shared Channel (PUSCH), and control channels include a Physical Uplink Control Channel, PUCCH, used to carry signalling from UEs including channel quality indication (CQI) reports and scheduling requests.

The above “channels” defined for various data and signalling purposes, should not be confused with the “channel” in the sense of the radio link between a UE and its serving base station(s), which is subject to fading and interference. To facilitate measurements of the channel by UEs, the base station inserts reference signals in the resource blocks as shown, for example, in FIG. 4. FIG. 4 shows the downlink reference signal structure for single antenna port transmission. As can be seen, one subframe has reference signals, denoted R, inserted at intervals within individual REs. Various kinds of reference signal are possible, and the reference signal structure or pattern varies when more antenna ports are in use.

In LTE (as distinct from LTE-A), downlink reference signals can be classified into a cell-specific (or common) reference signal (CRS), an MBSFN reference signal used in MBMS (not relevant for present purposes), and user equipment-specific reference signals (UE-specific RS, also referred to as demodulation reference signals, DM-RS). There is also a positioning reference signal.

The CRS is transmitted to all the UEs within a cell and used for channel estimation. The reference signal sequence carries the cell identity. Cell-specific frequency shifts are applied when mapping the reference signal sequence to the subcarriers. A UE-specific reference signal is received by a specific UE or a specific UE group within a cell. UE-specific reference signals are chiefly used by a specific UE or a specific UE group for the purpose of data demodulation.

CRSS are transmitted in all downlink subframes in a cell supporting non-MBSFN transmission, and can be accessed by all the UEs within the cell covered by the eNodeB, regardless of the specific time/frequency resource allocated to the UEs. They are used by UEs to measure properties of the radio channel—so-called channel state information or CSI. Meanwhile, DM-RSs are transmitted by the eNodeB only within certain resource blocks that only a subset of UEs in the cell are allocated to receive. Starting with Release 10 of the specifications, LTE is referred to as LTE-Advanced (LTE-A). A new reference signal in LTE-A is a Channel State Information Reference Signal (CSI-RS). To minimise interference, CSI-RS is only transmitted once every several subframes. In the Release 10 specifications, configurations of CSI-RS patterns are defined for 1, 2, 4 or 8 antenna ports. Their purpose is to allow improved estimation of the channel for more than one cell for feeding back channel quality information and possibly other related parameters to the network (compared with using CRS). CSI-RS patterns in time and frequency can be configured by higher layers to allow considerable flexibility over which resource elements (REs) contain them.

To support future Coordinated Multipoint, CoMP operation (see below), a UE compliant with LTE Release 10 can be configured with multiple CSI-RS patterns specific to its serving cell:
one configuration for which the UE shall assume non-zero transmission power for the CSI-RS; and
zero or more configurations for which the UE shall assume zero transmission power.

The purpose of the ‘zero power CSI-RS patterns’ is to ensure that a cell so-configured can safely be assumed by the UE to not transmit in the REs which will contain CSI-RS of the cells it is cooperating with in a CoMP scenario. Although CoMP is not directly supported by the LTE Release 10 specifications, knowledge of the presence of zero power CSI-RS patterns can be used by a Release 10 UE to mitigate their possible impact on data transmissions using PDSCH.

It should be mentioned that reference signals are also defined on the uplink, in particular a Sounding Reference Signal (SRS) transmitted by the UE, which provides channel information to the eNodeB.

A UE must successfully perform a cell search procedure and obtain synchronization with a cell before communicating with the network. Each cell is identified by a physical layer cell identity (PCI), 504 of which are defined in LTE. These are arranged hierarchically in 168 unique cell layer identity groups each containing three physical layer identities. To carry the physical layer identity and the physical layer cell identity group, two signals are provided: the primary and secondary synchronization signals (PSS and SSS). Specified in 3GPP TS36.211, hereby incorporated by reference, the PSS specifies one of three values (0, 1, 2) to identify the cell's physical layer identity, and the SSS identifies which one of the 168 groups the cell belongs to. In this way it is only necessary for PSS to express one of three values whilst SSS expresses one of 168 values. PSS is a 62-bit signal based on a Zadoff-Chu sequence, and SSS uses a combination of two 31-bit sequences which are scrambled by use of a sequence derived from the physical layer identity. Both PSS and SSS are transmitted in fixed resources by all cells so that they can be detected by any UE within range of the signal. Conventionally, each of the PSS and SSS is transmitted twice per frame, in other words with a 5 ms periodicity (and consequently, only in some subframes). For example, PSS and SSS are both transmitted on the first and sixth subframe of every frame as shown in FIGS. 5A and 5B. FIG. 5A shows the structure of PSS AND SSS and PBCH in the case of an FDD system (using a normal CP), and FIG. 5B shows the same thing in the case of TDD.

Successfully decoding the PSS and SSS allows a UE to obtain timing and identity for a cell. In a cell with more than one antenna port, the port from which PSS and SSS are transmitted may change over time, although they are both transmitted from the same port in a given subframe.

Once a UE has decoded a cell's PSS and SSS it is aware of the cell's existence and may decode the MIB in the PBCH referred to earlier. Depending on whether the system is using FDD or TDD, PBCH occupies the slots following or preceding PSS and SSS in the first subframe, as can be seen by comparing FIG. 5A and FIG. 5B. Like the synchronization signal SSS, PBCH is scrambled using a sequence based on the cell identity. The PBCH is transmitted every frame, thereby conveying the MIB over four frames.

The UE will then wish to measure the cell's reference signals (RSs). For current LTE releases, the first step is to locate the common reference signals CRS, the location in the frequency domain of which depends on the PCI. Then the UE can decode the broadcast channel (PBCH). In addition, the UE can decode PDCCH and receive control signalling. In particular, in the case of Transmission Mode 9, the UE may need to measure the radio channel using the Channel State Information RS (CSI-RS) mentioned above.

Inter-cell interference may arise, for example, because the frequency resources (i.e. the carriers and subcarriers) utilised for transmitting data to UEs in one cell are identical to the frequency resources in use in an adjacent cell. Moreover the “adjacent” cells may in fact lie entirely one within another, as for example when a Home eNodeB is deployed within an existing macro cell (see FIG. 7, described below).

MIMO techniques may be combined with coordination of the transmissions among multiple transmission points or base stations to eliminate or reduce this inter-cell interference. This coordination can reduce or eliminate inter-cell interference among coordinated cells (or coordinated portions of cells) and this can result in a significant improvement in the coverage of high data rates and overall system throughput. However, the trade-off for this improvement is that the coordination of transmissions in multi-cellular MIMO systems requires channel state information (CSI) and data information to be shared among the coordinated transmission points.

Such coordinated multi-cell MIMO transmission/reception (also called coordinated multi-point transmission/reception or CoMP) may be used to improve the coverage of high data rates, cell-edge throughput and/or to increase system throughput. The downlink schemes used in CoMP include “Coordinated Scheduling and/or Coordinated Beamforming (CS/CB)” and “Joint Processing/Joint Transmission (JP/JT)”. An additional technique which may be employed is aggregation of multiple carriers (CA) to increase the available peak data rate and allow more complete utilisation of available spectrum allocations.

In CS/CB, data to a single UE is transmitted from one transmission point, but decisions regarding user scheduling (i.e. the scheduling of timings for transmissions to respective user equipments) and/or beamforming decisions are made with coordination among the cooperating cells (or cell sectors). In other words, scheduling/beamforming decisions are made with coordination between the cells (or cell sectors) participating in the coordinated scheme so as to prevent, as far as possible, a single UE from receiving signals from more than one transmission point.

On the other hand, in JP/JT, data to a single UE is simultaneously transmitted from multiple transmission points to (coherently or non-coherently) improve the received signal quality and/or cancel interference for other UEs. In other words the UE actively communicates in multiple cells and with more than one transmission point at the same time. Further details of CoMP as applied to LTE can be found in the document 3GPP TR 36.814, also incorporated by reference.

In CA, discrete frequency bands are used at the same time (aggregated) to serve the same user equipment, allowing services with high bandwidth demands (up to 100 MHz) to be provided. CA is a feature of LTE-A which allows LTE-A-capable terminals to access several frequency bands simultaneously whilst retaining compatibility with the existing LTE terminals and physical layer. CA may be considered as an complement to JP for achieving coordination among multiple cells, the difference being (loosely speaking) that CA requires coordination in the frequency domain and JP in the time domain.

FIGS. 6(a) and (b) schematically illustrates the working principles of the two above-mentioned categories of downlink transmission used in CoMP, although it should be noted that the Figure may not reflect the true distribution of base stations vis-à-vis cells in a practical wireless communication system. In particular, in a practical wireless communication system, the cells extend further than the hexagons shown in the Figure so as to overlap to some extent, allowing a UE to be within range of more than one base station at the same time. Furthermore, it is possible, in LTE for example, for the same base station (eNodeB) to provide multiple overlapping cells, normally using distinct carrier frequencies. Nevertheless, FIG. 6 is sufficient for present purposes to illustrate the principles of CS/CB and JP downlink transmission schemes respectively, used in CoMP.

Joint Processing (JP) is represented in FIG. 6(a) in which cells A, B and C actively transmit to the UE, while cell D is not transmitting during the transmission interval used by cells A, B and C.

Coordinated scheduling and/or coordinated beamforming (CS/CB) is represented in FIG. 5(b) where only cell B actively transmits data to the UE, while the user scheduling/beamforming decisions are made with coordination among cells A, B, C and D so that the co-channel inter-cell interference among the cooperating cells can be reduced or eliminated.

In the operation of CoMP, UEs feed back channel state information. The channel state information is often detailed, and often includes measurements of one or more of channel state/statistical information, narrow band Signal to Interference plus Noise Ratio (SINR), etc. The channel state information may also include measurements relating to channel spatial structure and other channel-related parameters including the UE's preferred transmission rank and precoding matrix.

As already mentioned, cells may be overlapping or even entirely contained within a larger cell. This is particularly the case for so-called Heterogeneous Networks.

FIG. 7 schematically illustrates part of a heterogeneous network in which a macro base station 10 covers a macro cell area MC, within which there are other, overlapping cells formed by a pico base station 12 (picocell PC) and various femto base stations 14 (forming femto cells FC). As shown a UE 20 may be in communication with one or more cells simultaneously, in this example with the macro cell MC and the picocell PC. The cells may not have the same bandwidth; typically, the macro cell will have a wider bandwidth than each pico/femto cell.

Some definitions are as follows:
Heterogeneous Network: A deployment that supports a mixture of more than one of macro, pico, femto stations and/or relays in the same spectrum.
Macro base station—conventional base stations that use dedicated backhaul and open to public access. Typical transmit power ˜43 dBm; antenna gain ˜12-15 dBi.
Pico base station—low power base station with dedicated backhaul connection and open to public access. Typical transmit power range from ˜23 dBm-30 dBm, 0-5 dBi antenna gain;
Femto base station ˜consumer-deployable base stations that utilize consumer's broadband connection as backhaul; femto base stations may have restricted association. Typical transmit power <23 dBm.
Relays—base stations using the same radio spectrum for backhaul and access. Similar power to a Pico base station.

In LTE, an example of a femto base station is the so-called Home eNodeB or HeNB.

The installation by network customers of base stations with a localised network coverage cell, such as femto base stations (Home eNodeBs) is expected to become widespread in future LTE deployments. A femto base station or pico base station can be installed in, for example, a building within which network subscriber stations experience high path loss in transmissions with a macro cell. Femto and pico base stations can be installed by a customer in his own premises. The femto and picocells thereby formed can improve network coverage, but for coordination among the various cells, it is preferable for all the femto and picocells to be under the control of the macro cell (more precisely the MeNB 10 of FIG. 7). When organized in this way, picocells can be regarded as transmission points of the base station, in addition to transmission points provided by the antenna ports of the base station itself.

Consider now a UE operating among a large collection of picocells which are under the control of an overlaid macrocell's eNodeB. Synchronization between all the cells is further assumed. If the UE were able to obtain information about the structure of the network from broadcast signalling, it would be able to make decisions about its interaction with the network without needing to receive potentially large amounts of higher-layer signalling describing the many available resources in a dense, complex, multi-layer scenario. Therefore, schemes to use existing signalling more efficiently to convey this information are of interest. Such schemes would also be of interest in the scenario of geographically distributed antennas which are part of the same cell controlled by a single eNodeB.

In this specification, both picocells and different sets of antennas within a macrocell at different geographical locations are referred to as Transmission Points (TPs).

At present, information for the UE regarding the behaviour of a given cell or cells and the UE's interaction with them cannot be obtained until the UE is synchronized. By “synchronized” is meant that the UE knows at least some details of the timing of transmissions from at least one cell, for example, in LTE, the timing of the OFDM symbols, subframes and/or radio frames. More efficient use of resources could be made if the broadcast signals such as PSS and SSS contained information which allowed the UE to obtain earlier information about the cells whose control signals it can receive.

### SUMMARY OF THE INVENTION

According to a first aspect of the present invention, there is provided a transmission method for use in a wireless communication system comprising at least one terminal and a base station controlling at least two transmission points wherein:
the transmission points each broadcast first signals, the first signals broadcast from different transmission points having respective predetermined locations in the time domain, relative to a predetermined timing reference;
the terminal receives the first signals broadcast from at least one of the transmission points; and
the respective locations in the time domain of the first signals received by the terminal provide information to the terminal relating to at least one of:
the location in the time and/or frequency domain of a second signal which at least one of the transmission points may transmit; and
one or more characteristics of a transmission point.

Preferably, with respect to the predetermined timing reference, transmissions in the system are structured in units of frames each having a plurality of subframes, and the respective locations in the time domain are respective subframes, such that each transmission point transmits the first signals in a different subframe.

The transmission points may belong to a macro cell provided by the base station and the pre-determined timing reference is a frame timing of the macro cell.

The respective predetermined locations in the time domain may be different for each transmission point, but this is not essential.

In preferred embodiments of the present invention the first signals are synchronization signals. In particular, in the case of an LTE wireless communication system the synchronization signals may be primary and/or secondary synchronization signals (PSS/SSS).

The respective locations in the time domain of the first signals from each transmission point will normally provide information relating to the same transmission point, but this is not essential. It would be possible for the information to relate to a different transmission point.

In one embodiment, the respective locations in the time domain of the first signals from each transmission point provide information relating to a reference signal transmitted as the second signal from the transmission point. In the case of LTE this would include, for example, CSI-RS. More specifically, the information may indicate a resource used for the reference signal, and/or a zero-power pattern of the reference signal.

In another embodiment, the information indicates whether or not the transmission point will transmit a broadcast channel (such as PBCH in LTE), as distinct from a broadcast signal.

In a further embodiment, the information indicates differences between broadcast channel information transmitted from the transmission point and broadcast channel information which applies to (or corresponds to) another transmission point, which other transmission point does not itself need to transmit that information. In this way it is possible for the transmission point to broadcast a reduced amount of information in its broadcast channel, the terminal acquiring any missing information from another source such as a broadcast channel from another transmission point.

In a still further embodiment, the information relating to one or more characteristics of a transmission point indicates a subframe configuration expected by the transmission point to be used for a reference signal transmitted from the terminal. In this way it is possible for the information to specify characteristics of a signal, expected by the transmission point, to be transmitted by the terminal.

Whilst one “first signal” as defined above may be used to convey information to the terminal, it is also possible to convey information by combining multiple first signals. Thus, in a further embodiment, combining the respective locations in the time domain of first signals transmitted from at least first and second transmission points provides information to the terminal relating to at least one of:
the location in the time and/or frequency domain of a signal which a third transmission point, not necessarily among those from which the terminal received the first signals, may transmit; and
one or more characteristics of the third transmission point.

In any of the above embodiments, at least two distinct types of first signal may be broadcast from each transmission point, in which case the information is provided at least partly by the presence or absence of each type of first signal as well as by the respective locations in the time domain of each type of first signal. In the case of LTE, the distinct types of signal may be PSS and SSS. In other words, the presence or absence of either PSS or SSS or both may convey information to the terminal.

In a further embodiment, the information relating to one or more characteristics of the transmission point indicates availability of a specific resource at the transmission point to receive a transmission from the terminal. In the case of LTE, this embodiment can be used, for example, to inform the terminal that the transmission point has reserved a certain resource for receiving a BSR from the terminal.

In a yet further embodiment the information indicates another frequency band, different from that used to transmit the first signal, being transmitted by the same transmission point.

In any method as defined above, it is possible that the base station controls at least one antenna system and the transmission points include different antenna ports of the same antenna system.

According to a second aspect of the present invention, there is provided a wireless communication system comprising at least one terminal and a base station controlling at least two transmission points wherein:
the transmission points are each arranged to broadcast first signals, the first signals broadcast from different transmission points having respective predetermined locations in the time domain relative to a pre-determined timing reference;
the terminal is arranged to receive the first signals broadcast from the transmission points; and
the respective locations in the time domain of the first signals received by the terminal provide information to the terminal relating to at least one of:
the location in the time and/or frequency domain of a second signal which at least one of the transmission points may transmit; and
one or more characteristics of a transmission point.

According to a third aspect of the present invention, there is provided a base station controlling at least two transmission points for transmitting signals to terminals within range of the transmission points, wherein:
the base station is arranged to control the transmission points to broadcast first signals, the first signals broadcast from different transmission points having respective predetermined locations in the time domain, relative to a pre-determined timing reference; and
the respective locations in the time domain of the first signals received by the terminal provide information to the terminal relating to at least one of:
the location in the time and/or frequency domain of a second signal which at least one of the transmission points may transmit; and
one or more characteristics of a transmission point.

An additional aspect of the present invention proves a terminal configured for use in any transmission method as defined above.

A further aspect relates to software for allowing wireless transceiver equipment equipped with a processor to provide the terminal or the base station as defined above. Such software may be recorded on a computer-readable medium.

Throughout this section and the claims, the term “cell” is intended also to include sub-cells.

Embodiments of the present invention provide a new way of providing cell-specific or transmission point (TP)-specific information to a UE based on the subframe in which a cell/TP transmits its primary and secondary synchronization sequences (PSS and/or SSS). The principal scenario of interest is a dense deployment of picocells/TPs which are under the control of an overlaid macrocell's eNodeB. Since the antenna port from which PSS/SSS are transmitted can change between subframes, the invention associates some information (such as zero power CSI-RS) related to the picocell/TP transmitting the PSS and/or SSS with a particular PSS/SSS and subframe combination. The table of associations could be provided by signalling from the macrocell eNodeB, and the information being associated can then be obtained by the UE from any picocell/TP it is in range of without additional signalling being necessary.

In general, and unless there is a clear intention to the contrary, features described with respect to one embodiment of the invention may be applied equally and in any combination to any other embodiment, even if such a combination is not explicitly mentioned or described herein.

As is evident from the foregoing, the present invention involves signal transmissions between base stations and user equipments in a wireless communication system. A base station may take any form suitable for transmitting and receiving such signals. It is envisaged that the base stations will typically take the form proposed for implementation in the 3GPP LTE and 3GPP LTE-A groups of standards, and may therefore be described as an eNodeB (eNB) (which term also embraces Home eNodeB or Home eNodeB) as appropriate in different situations. However, subject to the functional requirements of the invention, some or all base stations may take any other form suitable for transmitting and receiving signals from user equipments, and for adapting signals for transmission to user equipments based on fed back channel state information.

Similarly, in the present invention, each user equipment may take any form suitable for transmitting and receiving signals from base stations. For example, the user equipment may take the form of a subscriber station (SS), or a mobile station (MS), or any other suitable fixed-position or movable form. For the purpose of visualising the invention, it may be convenient to imagine the user equipment as a mobile handset (and in many instances at least some of the user equipments will comprise mobile handsets), however no limitation whatsoever is to be implied from this.

### BRIEF DESCRIPTION OF THE DRAWINGS

Reference is made, by way of example only, to the accompanying drawings in which:

FIG. 1 illustrates a generic frame structure used in LTE;

FIG. 2 illustrates resource blocks (RBs) and resource elements (REs) in a downlink subframe;

FIG. 3 shows the mapping between logical channels, transport channels and physical channels in LTE;

FIG. 4 shows one pattern of insertion of reference signals within a downlink subframe;

FIG. 5A shows slot and subframe allocation of synchronization signals and a broadcast channel in the case of an FDD-based LTE system;

FIG. 5B shows slot and subframe allocation of synchronization signals and a broadcast channel in the case of a TDD-based LTE system;

FIG. 6A schematically illustrates joint processing (JP) downlink transmission used in CoMP;

FIG. 6B schematically illustrates coordinated scheduling and/or beamforming (CS/CB) downlink transmission used in CoMP;

FIG. 7 schematically illustrates a heterogeneous network in which a macro cell, pico and femto cells are overlapping;

and

FIG. 8 is a flowchart of the main steps involved in a method embodying the invention.

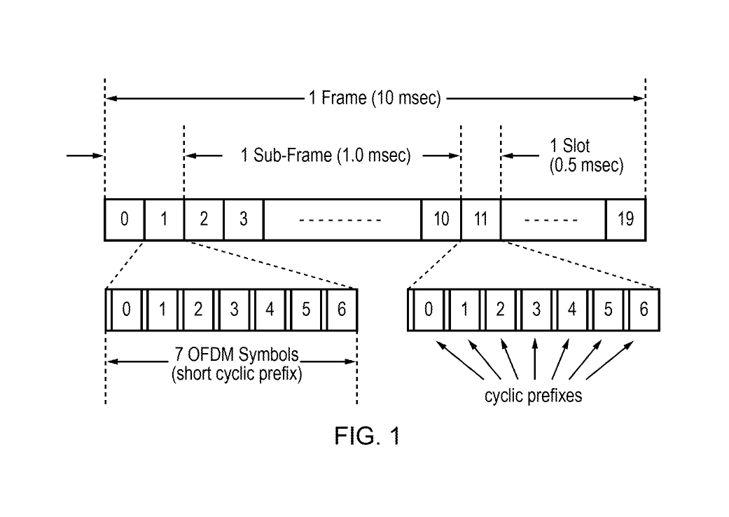

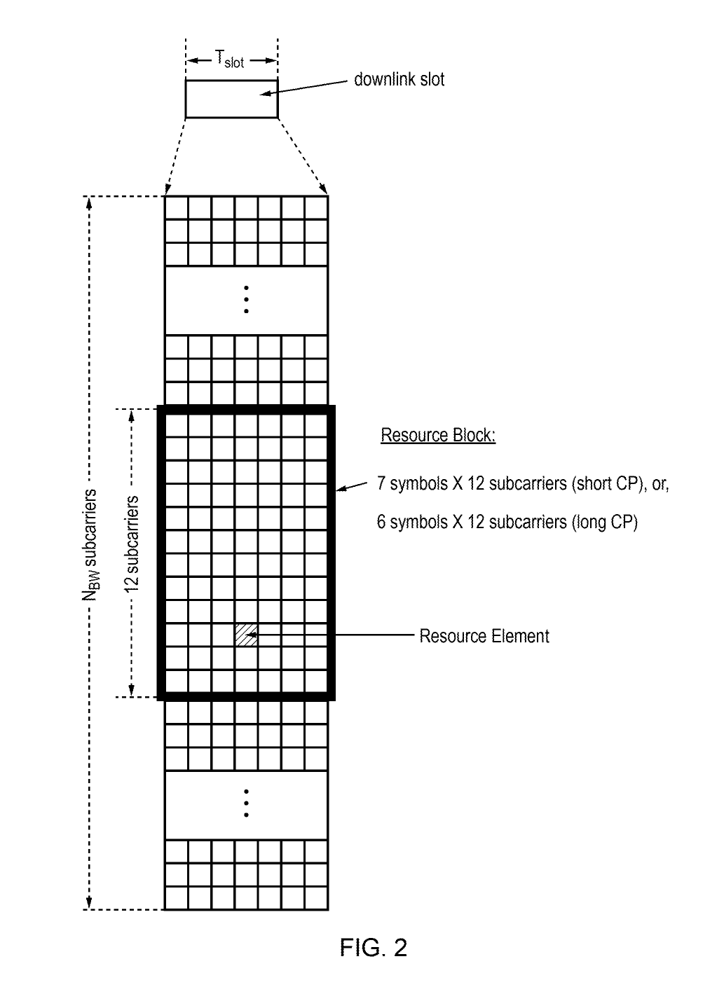

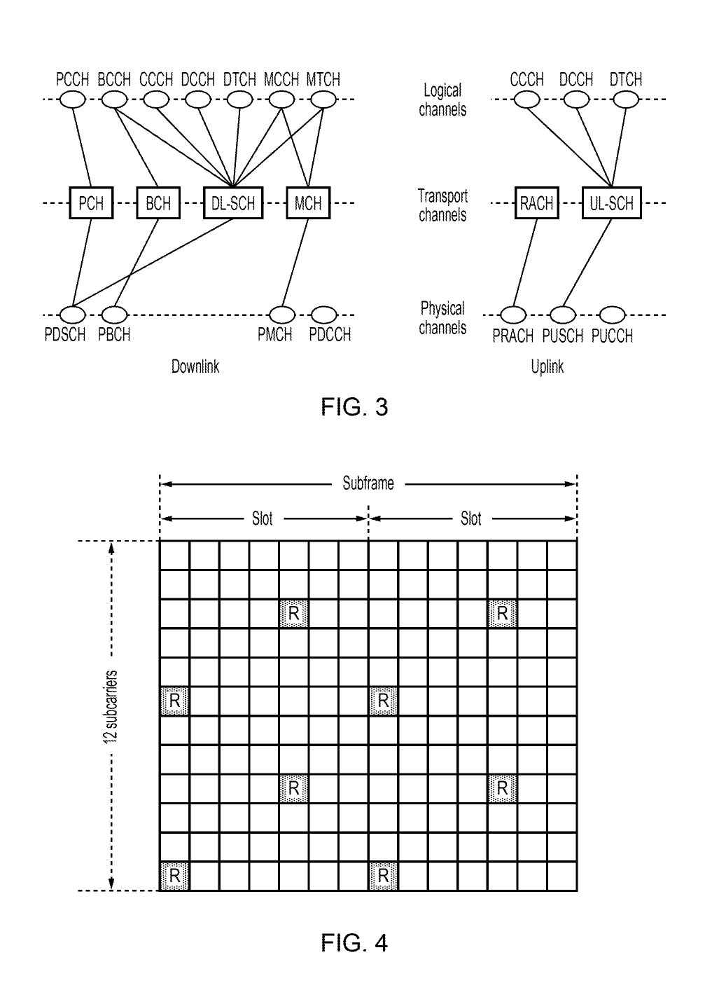

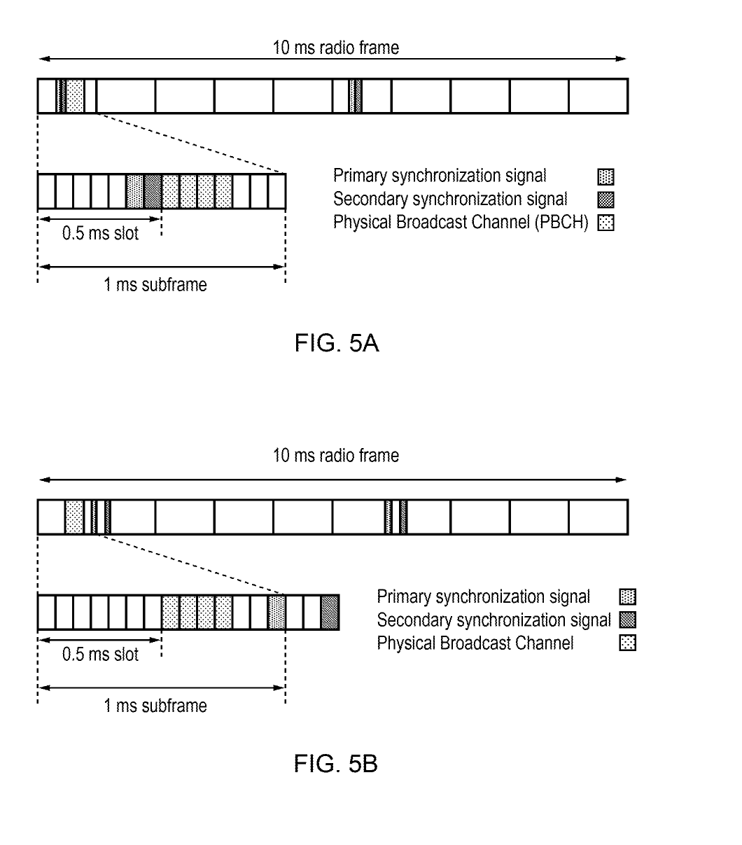

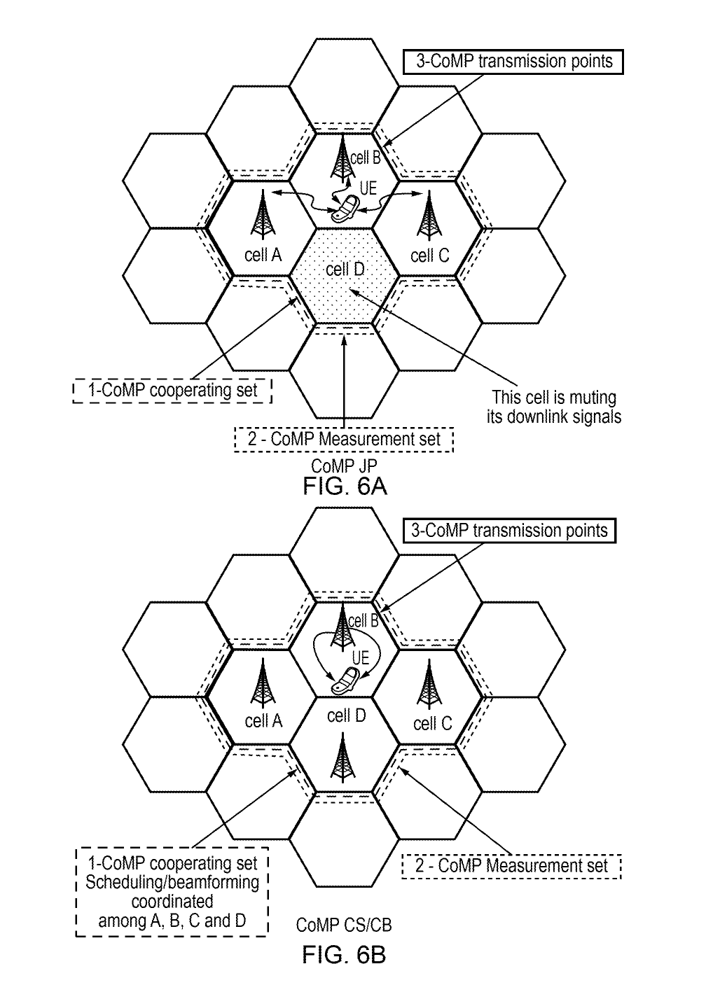

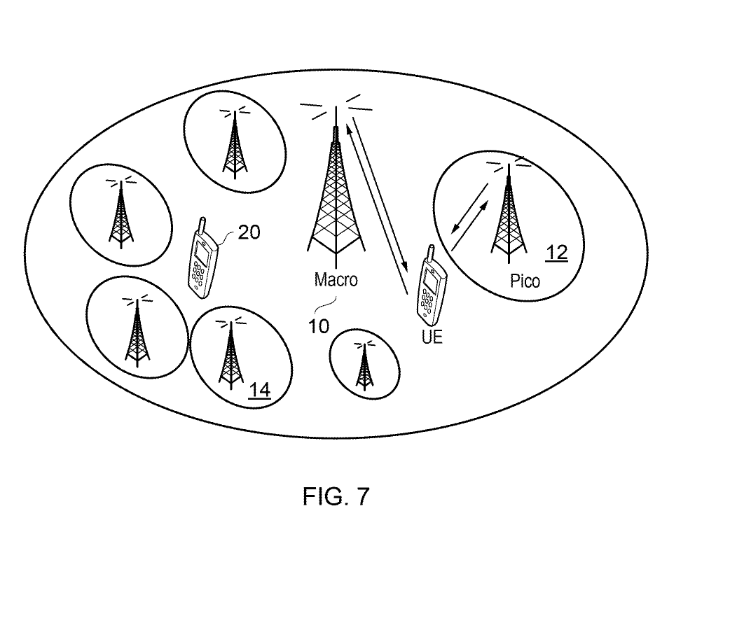

### DETAILED DESCRIPTION

Conventionally in LTE, PSS and SSS are always transmitted in the same two subframes within a radio frame (depending only on whether the network is FDD or TDD). However, the LTE specifications already allow a base station (or macrocell) to transmit PSS and SSS from different antenna ports in different subframes. In other words which antenna port is transmitting PSS and SSS can change from one transmission of them to the next, in order to benefit from time-switched antenna diversity. As already mentioned, antenna ports can more generally be considered as transmission points of the base station, and picocells associated with the base station may also be considered as transmission points. Thus, the term “transmission point” is used henceforth to include both.

A principle of embodiments of the present invention is to associate information about the transmission point (or possibly, a different transmission point) with when it transmits PSS and/or SSS (henceforth denoted “PSS/SSS”). This invention is envisaged primarily for application in the case of a large collection of geographically distributed transmission points (TPs) under the general coordination of a single macrocell. The invention could also be applied to TPs corresponding to picocells controlled by an overlaid macrocell eNodeB.

In this scenario, each transmission point is arranged to transmit PSS/SSS in a different subframe so that the PSS/SSS is transmitted from each transmission point in turn. The above-mentioned principle allows the controlling eNB to provide the UE with an association between the subframe in which a particular PSS/SSS is transmitted and some information regarding the corresponding transmission point (picocell and/or antenna ports). Since the LTE specifications already allow PSS and SSS to be transmitted from different antenna ports in different subframes, the above principle can be applied without requiring any change in the specifications

The transmission point can be identified by the UE on the basis of the subframe in which PSS/SSS is detected. A UE near a given transmission point will normally only receive PSS/SSS from that transmission point, and thus, from the UE point of view, it may appear that PSS/SSS is only transmitted in some of the subframes in which it would normally be present, because PSS/SSS transmitted from other transmission points in other subframes might not be received by the UE, if those transmission points are too distant. However, it is assumed that generally UEs will be able to receive PSS/SSS from more than one transmission point.

In the case, for example, of associating CSI-RS resources with a particular PSS/SSS—subframe combination, this allows the UE to determine on which CSI-RS resources it should make channel measurements. This allows the transmission points and/or pico antenna cells to dynamically indicate their presence to the UE and also to be dynamically included (or excluded) from a particular UE's knowledge of, or assumptions about, the structure of the network. This new capability is enabled primarily with existing physical-layer signalling which would normally have been transmitted in any case, and offers the opportunity to reduce the higher-layer signalling burden in some embodiments.

This invention can be used in way which is backwards compatible with UEs of a previous release. For example, if the same PSS/SSS are transmitted in different subframes, a legacy UE which detected these signals would assume that they originated from the same cell. If different PSS/SSS are transmitted in different subframes, a legacy UE which detected these signals would assume that they originated from different cells.

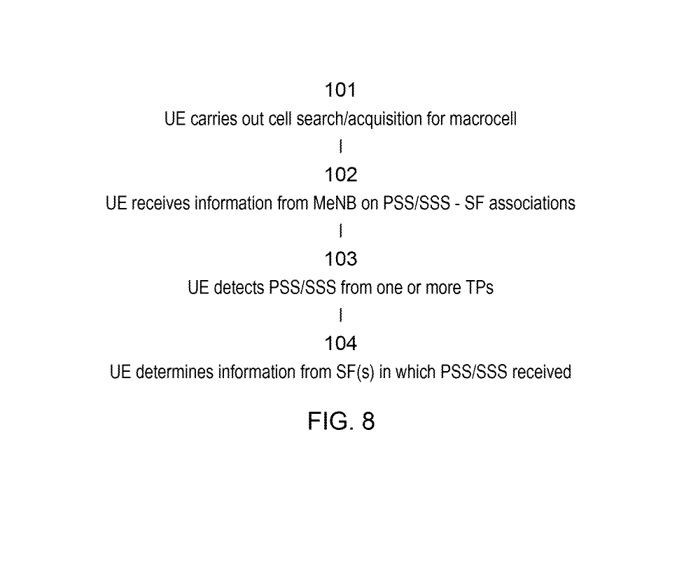

FIG. 8 is a flowchart outlining the scheme proposed by the present invention. In general, the process for conducting the above embodiments can be represented as:

Step 101: UE carries out cell search and acquisition procedure for the macrocell.

Step 102: UE receives information from the MeNB regarding PSS/SSS—subframe associations to information relevant to the embodiment.

Step 103: At some later time, the UE attempts to join a femto or picocell managed by the MeNB. To do so it UE detects PSS/SSS from at least one TP.

Step 104: In addition to decoding PSS/SSS for the purpose of synchronization, the UE derives information from at least the subframe(s) in which PSS/SSS were detected.

Some specific embodiments of the present invention will now be described.

In general, unless otherwise indicated, the embodiments described below are based on LTE, where the network operates using FDD and comprises one or more eNodeBs, each controlling one or more downlink cells, each downlink cell having a corresponding uplink cell. Each DL cell may serve one or more terminals (UEs) which may receive and decode signals transmitted in that serving cell.

As already mentioned, each cell transmits a number of signals and channels in broadcast to all UEs, whether they are being served by the cell or not: the PSS, SSS and PBCH. These convey timing information, PCI, and other essential system information common to the cell. Other information is transmitted to UEs being served by the cell, on channels including PDCCH. A PDCCH message typically indicates whether the data transmission will be in the uplink (using PUSCH) or downlink (using PDSCH), it also indicates the transmission resources, and other information such as transmission mode, number of antenna ports, data rate, number of codewords enabled. In addition PDCCH may indicate which reference signals may be used to derive phase reference(s) for demodulation of a DL transmission. Reference signals for different antenna ports, but occupying the same locations, are distinguished by different spreading codes.

In general, the cell ID (PCI) is indicated by the combination of sequences used for PSS and SSS. However, the embodiments below can be understood to be based on the UE receiving either PSS or SSS or both.

### First Embodiment

### CSI-RS Resource Identification

In a first embodiment, there is a macrocell eNB (MeNB) and transmission points (TPs) each consisting of at least one antenna port (AP) under the control of the MeNB. A UE is assumed to have joined the network by acquiring the macrocell.

The TPs sequentially transmit PSS/SSS in turn over a series of subframes. The association between a PSS/SSS in a given subframe and a transmission point, and a corresponding association with a CSI-RS resource is indicated to the UE (e.g. via higher layer signalling) Thus the subframe in which a UE detects a particular PSS/SSS is used to indicate which resources the UE should measure CSI-RS in for that TP.

If the UE can detect multiple PSS/SSS in a given subframe from different transmission points, it may measure CSI-RS as implied by, e.g.:
only the strongest PSS/SSS detected
any number of the detected PSS/SSS
only those TP s which have been indicated separately by higher-layer signalling from the MeNB

PSS/SSS transmitted from outside the macrocell would not be synchronized to the macrocell and therefore would appear to the UE as interference. The association of PSS/SSS subframes to CSI-RS resources can be provided by signalling from the MeNB, or in the system specifications. This association could be cell-specific or UE-specific. If it is UE-specific, different UEs can be told to measure different CSI-RS resources from the same TP, whereas if it is cell-specific they will all measure the same CSI-RS resources.

In a variation on this embodiment, each TP corresponds to a picocell, and the subframe association indicates for which picocell the UE should measure CSI-RS. This would be useful in the situation where there is an unstructured collection of transmission points or picocells.

In a variation on this embodiment, the subframe association instead indicates which CSI-RS sequences the UE should measure.

### Second Embodiment

### CSI-RS Zero-Power Pattern Identification

In a CoMP scenario (see above), it is important for the UE to know both the zero-power and non-zero-power CSI-RS patterns. In Release-10 of LTE there are 32 CSI-RS configurations and 16 zero-power patterns.

Thus, in a second embodiment the PSS/SSS—subframe association indicates the zero-power CSI-RS patterns which will be used in association with the TP. Otherwise, this is the same as the first embodiment.

### Third Embodiment

### PBCH Availability

A third embodiment is like the first, except that certain among the PSS/SSS—subframe associations indicate that the relevant TP, representing a picocell in this case, will not transmit PBCH. Instead, the information normally obtained from the picocell's PBCH, in other words the MIB (see above) is to be obtained by some other means.

In one variation, this picocell information is identical to that for the MeNB and can be obtained by decoding the MeNB's PBCH. This avoids the need for transmitting PBCH from the picocells, which will reduce both pico-to-macro PBCH interference and inter-pico PBCH interference in a dense picocell environment with a macro overlay. Clearly, this embodiment is applicable where the information carried on PBCH is common among the macrocell and the participating picocells.

In another variation, the content of the MIB is provided to the UE by higher layer signalling from the MeNB. In this case the information can be different for each PSS/SSS-subframe combination. The PSS/SSS may indicate that the MIB for the picocell should be obtained from the macro cell MIB, or alternatively the PSS/SSS may indicate that the picocell MIB is not present.

In a further variation, some information can be assumed by the UE to be the same as for macro cell PBCH, and some information is different.

### Fourth Embodiment

### Differential PBCH Indication

A fourth embodiment is like the third, except that the picocell may have some differences in the information to be transmitted by PBCH. In this case, the PSS/SSS—subframe association for the picocell also indicates the differences in BCH information to be interpreted by the UE. For example, the PSS/SSS—subframe association could indicate that all information is the same between macro and pico BCH, apart from the indication of PHICH size which takes some other value in the picocell.

In this way it is possible to indicate the differences between broadcast information from a first transmission point, and broadcast information applicable to a second transmission point, the second transmission point not necessarily transmitting a broadcast channel.

The system specifications could be expanded to include one or more tables for linking PSS/SSS-subframe associations to specific differences in PBCH contents.

### Fifth Embodiment

### Srs

As already mentioned, SRS is an uplink reference signal. A fifth embodiment is like the first, except that the PSS/SSS—subframe associations indicate the TP's (or picocell's, in this case) SRS subframe configuration parameter, in other words the subframe pattern in which the TP/picocell expects to receive SRS. Sixteen such configurations are currently defined in LTE (see 3GPP TS36.211 referred to earlier).

In a variation on this embodiment, the associations indicate instead the maximum SRS bandwidth supported by the picocell.

### Sixth Embodiment

### Joint PSS/SSS—Subframe Association Across TPs

In a sixth embodiment, the joint set of more than one PSS/SSS—subframe association conveys information relevant to one or more of the above embodiments. This allows the UE to decode fewer subframes containing PSS/SSS but still obtain information about TPs whose PSS/SSS it has not attempted to decode. Receiving a first PSS/SSS in subframe1 from TP1 and a second PSS/SSS in subframe 2 from TP2 can imply (i) information about TP1; and (ii) information about TP2; and/or by linking the associations of TP to subframe, (iii) information about a third TP. This can be achieved by providing a lookup table in which one axis is PSS/SSS from TP1+subframe1, the other axis is PSS/SSS from TP2+subframe2, and the information about the third TP is provided at the intersection of the two.

Taking CSI-RS as the information to be conveyed for example, if the UE receives PSS/SSS from TP1-Fsubframe1 which can imply CSI-RS pattern 1; PSS/SSS from TP2+subframe2 which can imply CSI-RS pattern 2, then the UE can assume that T3 transmits (e.g. is configured with) a CSI-RS pattern which depends only on the previous two.

### Seventh Embodiment

### Single Synchronization Signal Transmission

As already mentioned, conventionally both PSS and SSS are always transmitted in the same subframe. In a seventh embodiment, instead of this conventional arrangement, a UE may receive PSS or SSS or both or neither in a particular subframe, with the combination conveying information according to previous embodiments. This provides four possible signalling states within a given subframe.

In a variation, the joint combination of receiving a PSS alone in one particular subframe and a SSS alone in another conveys the information.

It should be noted that, unlike the preceding embodiments, this embodiment would involve a change in the LTE specifications for synchronization sequences. In addition, since normally both PSS and SSS are needed by the UE to derive the PCI, an alternative mechanism would be needed. For example the UE could use PSS and SSS from different subframes; or a new type of synchronization sequence could be employed (either in addition to, or instead of PSS and SSS) which carries the whole PCI. Alternatively the UE may be configured to assume a default value for SSS if it only receives PSS, and vice-versa.

### Eighth Embodiment

### Resource Reservation Indication

In an eighth embodiment, a UE-specific configuration from the network or MeNB instructs the UE to recognise a particular TP to PSS/SSS—subframe association which indicates that the TP will reserve some specific UL resources for the UE for some given amount of time, the specific resources being identified as part of the indication.

In a variation of this embodiment, the PSS/SSS-subframe association indicates that some certain cell-specific UL resources are reserved for use by any UE for a particular purpose, either with or without time limitation.

An example of this is a promise to reserve enough PUSCH resource to permit the UE to transmit BSR to the TP without having to execute the SR procedure. The Buffer Status reporting procedure is used to provide the serving eNodeB with information about the amount of data available for transmission in the uplink buffer(s) of the UE.

In another variation of this embodiment, the specific UL resources could be associated with any transmission point, not necessarily the one from which the PSS/SSS was received. In this case the PSS/SSS—subframe association would indicate which TP the reservation relates to, which could be different from the transmitting TP.

This reservation can be changed (or cancelled) by altering the UE-specific configuration from the MeNB.

This embodiment could also be used in the context of MTC devices to extend the invention described in the applicant's co-pending International Patent Application with reference 11-52824FLE, to indicate reservation of RACH resources based on detecting a PSS/SSS—subframe configuration.

### Ninth Embodiment

### Frequency Band Indication

A ninth embodiment is like the first, except that the PSS/SSS-subframe association indicates information about another frequency band (i.e. carrier) being transmitted by the same transmission point as is transmitting the relevant PSS/SSS. This information would typically include radio resource configuration (RRC) information relevant to allowing the UE to access, measure, etc. the other carrier.

To summarise, embodiments of the present invention provide a new way of providing cell-specific or transmission point (TP)-specific information to a UE based only, or substantially, on the subframe in which a cell/TP transmits its primary and secondary synchronization sequences (PSS and SSS). The principal scenario of interest is a dense deployment of picocells/TPs which are under the control of an overlaid macrocell's eNodeB. Since the antenna port from which PSS/SSS are transmitted can change between subframes, the invention associates some information (such as zero power CSI-RS) related to the picocell/TP transmitting the PSS/SSS with a particular PSS/SSS and subframe combination. The table of associations could be provided by signalling from the macrocell eNodeB, and the information being associated can then be obtained by the UE from any picocell/TP it is in range of without additional signalling being necessary.

Various modifications are possible within the scope of the present invention.

The invention has been described with reference to LTE FDD, but could also be applied for LTE TDD, and to other communication systems such as UMTS.

Reference has been made above to “cells” but these need not correspond one-to-one with base stations or transmission points. Different cells may be defined on the downlink and uplink. Multiple cells may be provided by the same transmission point. The term “cells” is thus to be interpreted broadly and to include, for example, sub-cells or cell sectors.

Although the embodiments illustratively refer to a macrocell and pico antenna ports, this does not constrain the network structures to which the invention could be applied.

Although the embodiments refer to current PSS and SSS, this does not constrain the applicability of the invention to future changes to specifications which alter the number, type, or resource allocation of these sequences. Whilst both PSS and SSS may be transmitted in accordance with embodiments of the present invention, as is apparent from the above-mentioned seventh embodiment, in the present invention it is not always necessary to transmit both PSS and SSS in the same subframe. Accordingly, the term “PSS/SSS” used in this specification is to be understood as meaning “PSS and/or SSS” unless the context demands otherwise.

As already mentioned the basic principle of embodiments of the present invention does not require any LTE specification changes. However, one possible specification change would be to introduce configuration of transmission of PSS/SSS from a particular antenna port in a particular subframe (identified by subframe number within a radio frame, and/or system frame number). Also, for the purposes of the 7th embodiment, as already mentioned it would be necessary to allow PSS and SS to be transmitted individually, or not at all, rather than both in the subframe.

Note that the embodiments, and particularly the seventh embodiment, can rely only on the detection of a particular PSS and/or SSS waveform rather than requiring an explicit decoding of the waveform to yield the actual sequences comprising them. Thus, in the seventh embodiment for example, information is conveyed by the subframes in which either or both or none of PSS and SSS are transmitted, rather than by their content (which in the case of only one of PSS and SSS alone, would not by itself determine the PCI).

The above embodiments may in general be combined so that the association of PSS/SSS from a particular TP to a subframe can indicate information according to more than one embodiment. For example, it could indicate both the CSI-RS resources and the zero-power CSI-RS patterns from a TP. A look-up table, stored in the UE, would allow different kinds of information to be conveyed in combination.

Whilst the above description has been made with respect to LTE and LTE-A, the present invention may have application to other kinds of wireless communication system also. Accordingly, references in the claims to “terminal” are intended to cover any kind of subscriber station, mobile terminal and the like and are not restricted to the UE of LTE.

In any of the aspects or embodiments of the invention described above, the various features may be implemented in hardware, or as software modules running on one or more processors. Features of one aspect may be applied to any of the other aspects.

The invention also provides a computer program or a computer program product for carrying out any of the methods described herein, and a computer readable medium having stored thereon a program for carrying out any of the methods described herein.

A computer program embodying the invention may be stored on a computer-readable medium, or it may, for example, be in the form of a signal such as a downloadable data signal provided from an Internet website, or it may be in any other form.

It is to be clearly understood that various changes and/or modifications may be made to the particular embodiment just described without departing from the scope of the claims.

### INDUSTRIAL APPLICABILITY

By allowing cell-specific or TP-specific information to be implied by a PSS/SSS—subframe association, the network can dynamically reconfigure itself without additional signalling to the UE, and the UE's knowledge of the structure of the network can be controlled, or limited, by the detectability of some simple broadcast signals. In some embodiments it allows reduction of interference between cells and macro/pico layers on broadcast channels, an important improvement in the Heterogeneous Network scenario described above. The UE can also automatically identify information about nearby cells/transmission points from the subframe timing of the PSS/SSS that it receives, for example, the configuration of CSI-RS.

What is claimed is:

1. A transmission method for use in a wireless communication system comprising at least one terminal and a base station controlling at least two transmission points wherein:
the transmission points each broadcast first signals, said first signals broadcast from different said transmission points having respective predetermined locations in the time domain, relative to a predetermined timing reference;
the terminal receives the first signals broadcast from at least one of the transmission points; and
the respective locations in the time domain of said first signals received by the terminal provide information to the terminal relating to at least one of:
the location in the time and/or frequency domain of a second signal which at least one of the transmission points may transmit; and
one or more characteristics of a transmission point.

2. The transmission method according to claim 1 wherein, with respect to said predetermined timing reference, transmissions in the system are structured in units of frames each having a plurality of subframes, and the respective locations in the time domain are respective subframes, such that each transmission point transmits said first signals in a different subframe.

3. The transmission method according to claim 2 wherein the transmission points belong to a macro cell provided by the base station and the pre-determined timing reference is a frame timing of the macro cell.

4. The transmission method according to claim 1 wherein the first signals are synchronization signals.

5. The transmission method according to claim 1 wherein the respective locations in the time domain of said first signals from each said transmission point provide information relating to the same transmission point.

6. The transmission method according to claim 1 wherein the respective locations in the time domain of said first signals from each said transmission point provide information relating to a reference signal transmitted as said second signal.

7. The transmission method according to claim 6 wherein the information relating to a reference signal to be transmitted as said second signal indicates a resource used for the reference signal.

8. The transmission method according to claim 6 wherein the information relating to a reference signal transmitted as said second signal indicates a zero-power pattern of the reference signal.

9. The transmission method according to claim 1 wherein the information indicates whether or not the transmission point will transmit a broadcast channel.

10. The transmission method according to claim 1 wherein the information indicates differences between broadcast information carried by a broadcast channel transmitted from the transmission point and broadcast information which applies to another transmission point.

11. The transmission method according to claim 1, wherein the information relating to one or more characteristics of a transmission point indicates a subframe configuration expected by the transmission point to be used for a reference signal transmitted from the terminal.

12. The transmission method according to claim 1 wherein combining the respective locations in the time domain of said first signals transmitted from at least first and second said transmission points provides information to the terminal relating to at least one of:
the location in the time and/or frequency domain of a signal which a third transmission point, not necessarily among those from which the terminal received said first signals, may transmit; and
one or more characteristics of the third transmission point.

13. The transmission method according to claim 1 wherein at least two distinct types of first signal can be broadcast from each transmission point and said information is provided at least partly by the presence or absence of each type of first signal as well as by the respective locations in the time domain of each type of first signal.

14. The transmission method according to claim 1 wherein the information relating to one or more characteristics of the transmission point indicates availability of a specific resource at the transmission point to receive a transmission from the terminal.

15. The transmission method according to claim 1 wherein the base station controls at least one antenna system and the transmission points include different antenna ports of the same antenna system.

16. A wireless communication system comprising at least one terminal and a base station controlling at least two transmission points wherein:
the transmission points are each arranged to broadcast first signals, said first signals broadcast from different said transmission points having respective predetermined locations in the time domain relative to a pre-determined timing reference;
the terminal is arranged to receive the first signals broadcast from the transmission points; and
the respective locations in the time domain of said first signals received by the terminal provide information to the terminal relating to at least one of:
the location in the time and/or frequency domain of a second signal which at least one of the transmission points may transmit; and
one or more characteristics of a transmission point.

17. A base station controlling at least two transmission points for transmitting signals to terminals within range of the transmission points, wherein:
the base station is arranged to control the transmission points to broadcast first signals, said first signals broadcast from different said transmission points having respective predetermined locations in the time domain, relative to a pre-determined timing reference; and
the respective locations in the time domain of said first signals received by the terminal provide information to the terminal relating to at least one of:
the location in the time and/or frequency domain of a second signal which at least one of the transmission points may transmit; and
one or more characteristics of a transmission point.

18. A terminal configured for use in the transmission method according to claim 1.
